(19) United States
(12) Patent Application Publication
(10) Pub. No.: US 2015/0207166 A1
(43) Pub. Date: Jul. 23, 2015

(54) FUEL CELL FOR IMPROVING FLOW FIELD UNIFORMITY AND REDUCING GAS PRESSURE LOSS

(71) Applicant: NATIONAL TSING HUA UNIVERSITY, Hsinchu (TW)

(72) Inventors: Che-Wun Hong, Hsinchu (TW); Hung-Hsiao Liu, Hsinchu (TW); Angel Giancarlo Miranda Canales, Hsinchu (TW)

(73) Assignee: NATIONAL TSING HUA UNIVERSITY, Hsinchu (TW)

(21) Appl. No.: 14/203,730

(22) Filed: Mar. 11, 2014

(30) Foreign Application Priority Data
Jan. 22, 2014 (TW) 103102327

(51) Int. Cl. H01M 8/24

(52) U.S. Cl. CPC H01M 8/2485

(57) ABSTRACT

A fuel cell for improving flow field uniformity and reducing gas pressure loss includes a fuel cell stack and a gas input unit. The gas input unit has a gas input passage, an input port, an input baffle plate and at least one perforated plate. An end of the gas input passage is connected to an end of the fuel cell stack. The input port is disposed on another end of the gas input passage. The input baffle plate is disposed in the gas input passage and located in front of the input port, and a gap exists between the input baffle plate and the input port. The perforated plate is disposed between the input baffle plate and the fuel cell stack.

### CROSS-REFERENCE TO RELATED APPLICATIONS

The entire contents of Taiwan Patent Application No. 103102327, filed on Jan. 22, 2014, from which this application claims priority, are incorporated herein by reference.

### BACKGROUND OF THE INVENTION

1. Field of the Invention

The present invention generally relates to a fuel cell and more particularly to a fuel cell for improving flow field uniformity and reducing gas pressure loss.

2. Description of Related Art

In recent years, as the energy shortage is growing and the environmental issues become more prominent, the fuel cell is widely expected as an environmentally friendly energy, which converts the chemical energy from a fuel (such as hydrogen) into electricity through a chemical reaction with oxygen or another oxidizing agent to produce electricity, so as to provide low-pollution energy.

FIG. 1A shows a cross-section view of a conventional fuel cell 100, FIG. 1B shows the input gas flowing in the fuel cell 100. As shown in FIG. 1A/1B, the fuel cell 100 includes a fuel cell stack 110, a gas input unit 120 and a gas output unit 130. The gas input unit 120 and the gas output unit 130 are respectively disposed on two opposite end of the fuel cell stack 110. However, when the fuel cell 100 is operating, the input gas would be introduced from the input port 124 and then be transmitted to the fuel cell stack 110 by a channel 122. When being transmitted, the input gas would directly impact on an impact area 112 of the fuel cell stack 110 and correspondingly generate separated-flows of the input gas, which then may flow into the fuel cell stack 110 from the peripheral region of the impact area 112. Therefore, the input gas could not be uniformly and simultaneously flow into the fuel cell stack 110, so that the pressure between the input port and the output port of the fuel cell stack 110 may be greatly reduced and the fuel cell 100 cannot be operated at the best overall efficiency.

A need has thus arisen to propose a novel fuel cell to overcome deficiencies of the conventional fuel cells.

### SUMMARY OF THE INVENTION

In view of the foregoing, it is an object of the embodiment of the present invention to provide a fuel cell for improving flow field uniformity and reducing gas pressure loss. The fuel cell with a configuration design of the baffle plate and perforated plate significantly improves the gas pressure loss and causes the input gas to uniformly flow into the fuel cell stack for enhancing the overall efficiency.

According to one embodiment, a fuel cell for improving flow field uniformity and reducing gas pressure loss includes a fuel cell stack and a gas input unit. The gas input unit has a gas input passage, an input port, an input baffle plate and at least one perforated plate. An end of the gas input passage is connected to an end of the fuel cell stack. The input port is disposed on another end of the gas input passage. The input baffle plate is disposed in the gas input passage and located in front of the input port, and a gap exists between the input baffle plate and the input port. The perforated plate is disposed between the input baffle plate and the fuel cell stack.

According to another embodiment, a fuel cell for improving flow field uniformity and reducing gas pressure loss includes a fuel cell stack, a gas input unit and a gas output unit. The gas input unit has a gas input passage, an input port, an input baffle plate and at least one perforated plate. An end of the gas input passage is connected to an end of the fuel cell stack. The input port is disposed on another end of the gas input passage. The input baffle plate is disposed in the gas input passage and located in front of the input port, and a gap exists between the input baffle plate and input port. The perforated plate is disposed between the input baffle plate and fuel cell stack. The gas output unit has a gas output passage, an output port and an output baffle plate. An end of the gas output passage is connected to another end of the fuel cell stack. The output port is disposed on another end of the gas output passage. The output baffle plate is disposed in the gas output passage and located in front of the output port, and a gap exists between the output baffle plate and the output port.

### BRIEF DESCRIPTION OF THE DRAWINGS

FIG. 1A shows a cross-sectional view of a conventional fuel cell;

FIG. 1B shows the input gas flowing in the fuel cell;

FIG. 2 shows a cross-section view of a fuel cell according to an embodiment of the present invention;

FIG. 3A shows a top view of the fuel cell of FIG. 2;

FIG. 3B shows a cross-sectional view taken along the line 3B-3B′ of FIG. 2;

FIG. 4 shows the input gas flowing in the fuel cell of FIG. 2; and

FIG. 5 shows a cross-section view of a fuel cell according to another embodiment of present invention.

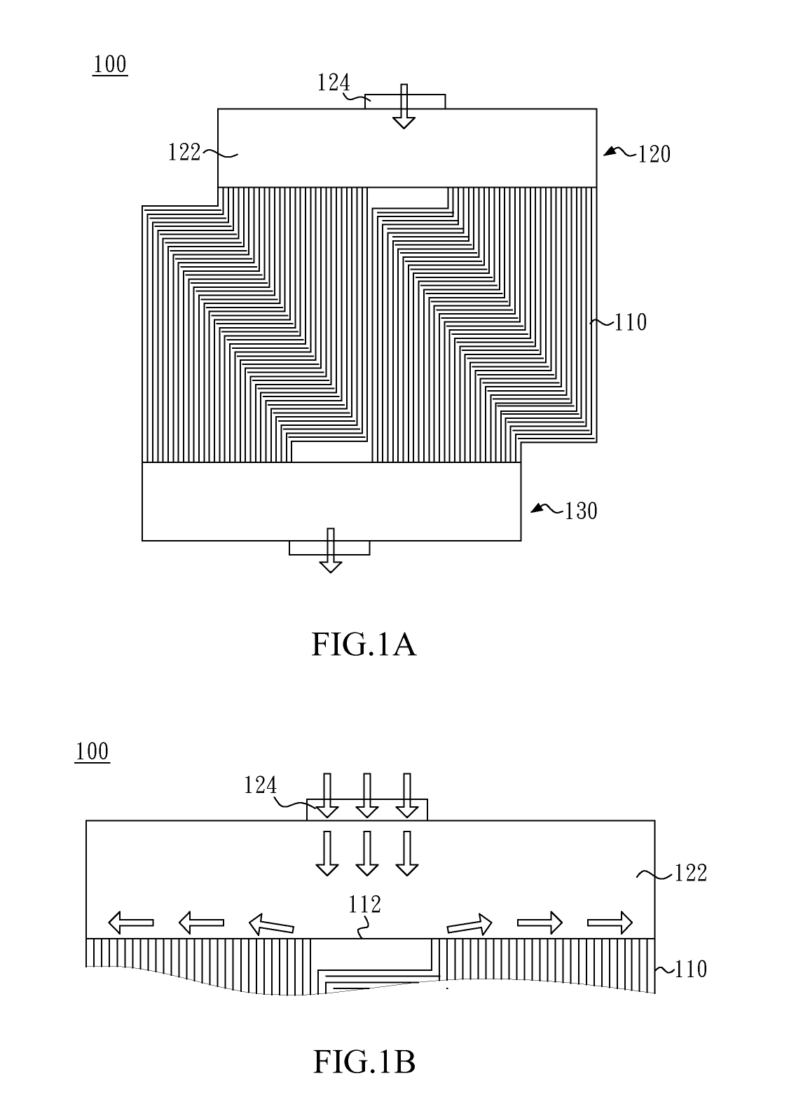

### DETAILED DESCRIPTION OF THE INVENTION

The detailed description of the present invention will be discussed in the following embodiments, which are not intended to limit the scope of the present invention, but can be adapted for other applications. While drawings are illustrated in details, it is appreciated that the quantity of the disclosed components may be greater or less than that disclosed, except expressly restricting the amount of the components.

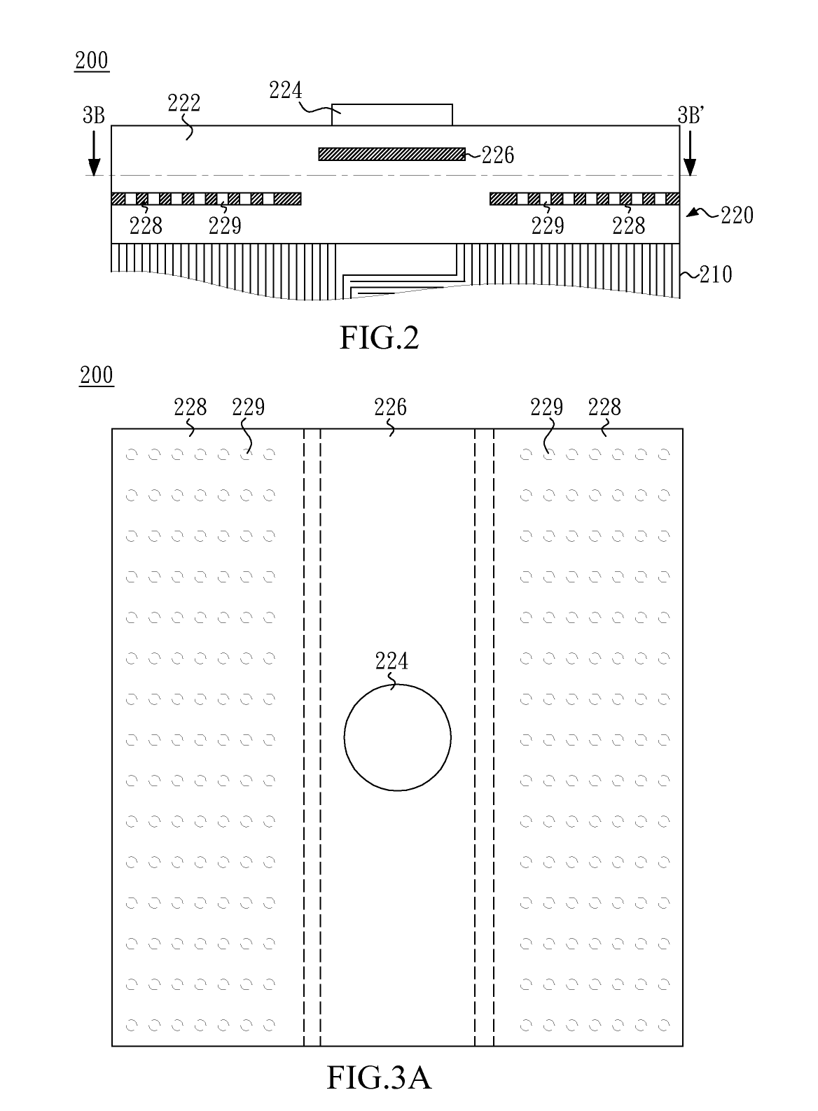

Referring to FIG. 2, FIG. 2 shows a cross-section view of a fuel cell according to an embodiment of the present invention. As shown in FIG. 2, a fuel cell 200 includes a fuel cell stack 210 and a gas input unit 220. The gas input unit 220 has a gas input passage 222, an input port 224, an input baffle plate 226 and at least one perforated plate 228. An end of the gas input passage 222 is connected to an end of the fuel cell stack 210. The input port 224 is disposed on another end of the gas input passage 222. The input baffle plate 226 is disposed in the gas input passage 222 and located in front of the input port 224, and a gap exists between the input baffle plate 226 and the input port 224. The perforated plate 228 is between disposed the input baffle plate 226 and the fuel cell stack 228.

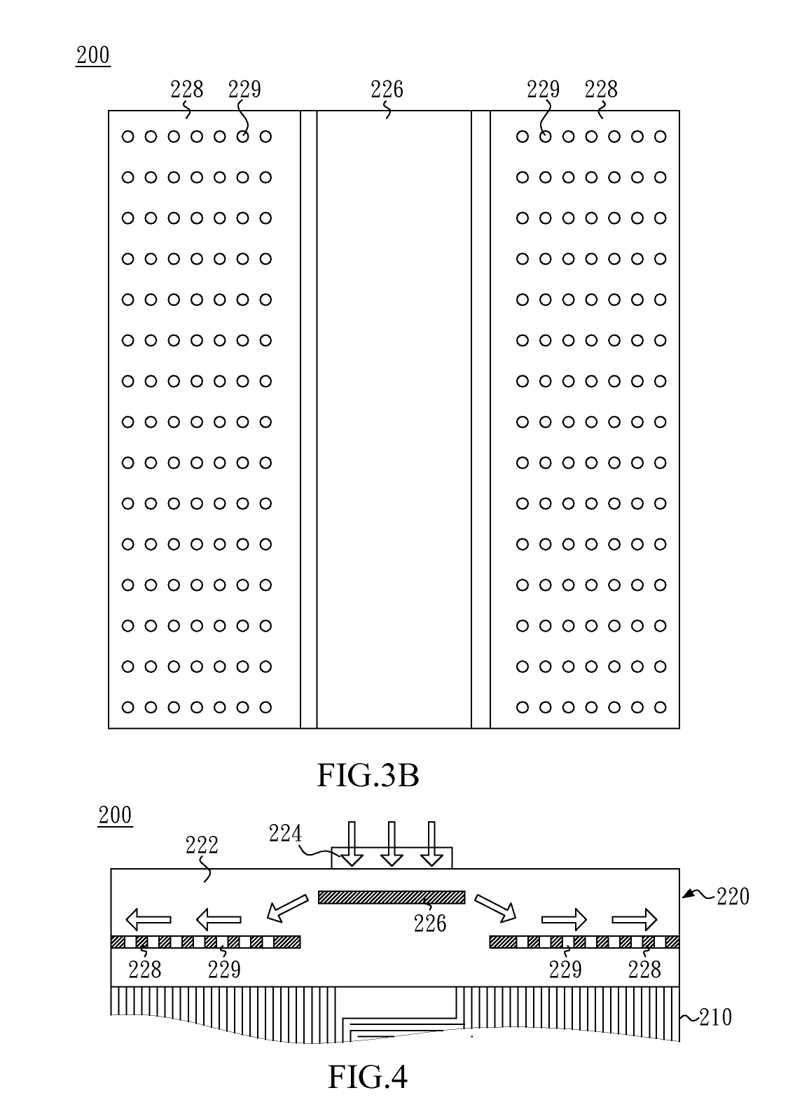

More particularly, referring to FIG. 3A/3B, FIG. 3A shows a top view of the fuel cell of FIG. 2, and FIG. 3B shows a cross-sectional view taken along the line 3B-3B′ of FIG. 2. As shown in FIG. 3A/3B, a width of the gas input passage 222 is greater than an aperture diameter of the input port 224, and a width of the input baffle plate 226 is greater than the aperture diameter of the input port 224. Therefore, when an input gas is introduced into the gas input passage 222, the input gas may completely and directly impact on the input baffle plate 226, and then generate separated flows of the input gas from the two sides of the input baffle plate 226 to diffuse into the fuel cell stack 210, so as to prevent the input gas from directly impacting on the fuel cell stack 210 and greatly reduce the gas pressure loss. Further, in this embodiment, the input baffle plate 226 has a rectangular shape. Two ends of the input baffle plate 226 may be respectively connected to two sidewalls of the gas input passage 222. However the present invention is not limited thereto, the shape of the input baffle plate 226 may be adjusted according to different needs of the actual design or the manufacturing process. For example, in another embodiment, only one end of the input baffle plate 226 is connected to the sidewall of the gas input passage 222.

Moreover, the perforated plate 228 has a plurality of holes 229. Thus, when the separated flows of the input gas is introduced through the perforated plate 228, the holes 229 may generate a stable gas flow with a uniform flow distribution to diffuse into the fuel cell stack 210. Furthermore, as shown in FIG. 3A/3B, the shape of the perforated plate 228 substantially complements the shape of the input baffle plate 226, in order to approximately cove the cross-section of the gas input passage 222. Therefore, the perforated plate 228 may significantly improve the flow field uniformity of the separated flows of the input gas, which is caused by the input baffle plate 226. In this embodiment, the perforated plate 228 has a rectangular shape. However, the present invention is not limited thereto, as the shape of the perforated plate 228 may be appropriately adjusted according to the needs of the actual design or the practical shapes of the input baffle plate 226 and the gas input passage 222, so as to gain the optimal gas flow distribution. Simultaneously, the gap between the perforated plate 228 and the input baffle plate 226, the size of the aperture diameter of the holes 229 and the distribution density of the holes 229 may be adjusted according to the practical needs of the desired overall gas flow distribution.

Referring to FIG. 4, FIG. 4 shows the input gas flowing in the fuel cell of FIG. 2. As shown in FIG. 4, when the input gas flows into the gas input passage 222 from the input port 224, the input baffle plate 226, disposed in front of the input port 224, may separate the input gas, and then the separated flows may flow to the perforated plate 228 from two sides of the input baffle plate 226. Afterwards, the perforated plate 228 and the holes 229 will provide a more uniform and steady flow field. Therefore, according to the configuration design of the fuel cell 200, the gas pressure loss may be significantly reduced and the flow field uniformity may be also greatly improved, in order to enhance the efficiency of the fuel cell.

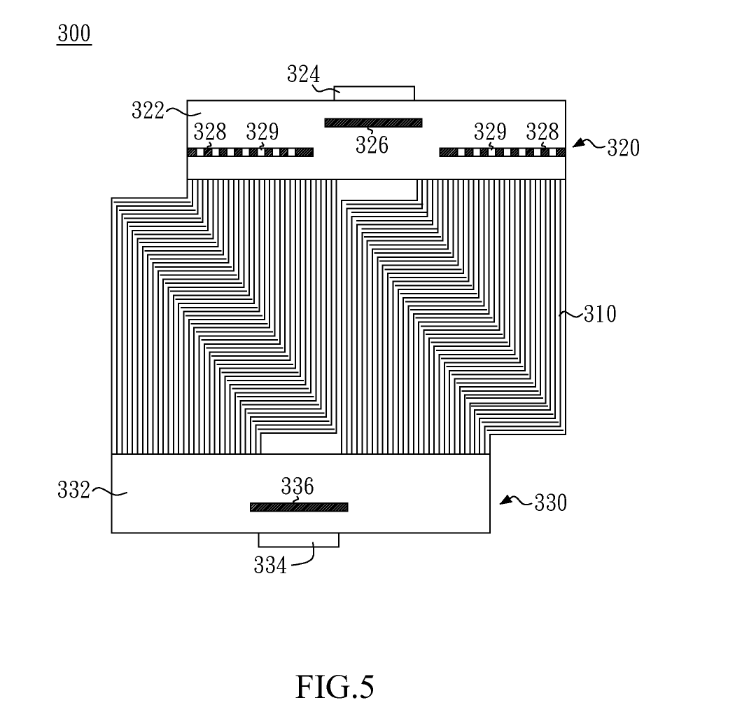

Referring to FIG. 5, FIG. 5 shows cross-section view of the fuel cell 300 according to another embodiment of the present invention. The fuel cell 300 includes a fuel cell stack 310, a gas input unit 320 and a gas output unit 330. The gas input unit 320 is disposed on an end of the fuel cell stack 310, and the gas output unit 330 is disposed on another end of the fuel cell stack 310. The gas output unit 330 includes a gas output passage 332, an output port 334 and an output baffle plate 336. An end of the gas output passage 332 is connected to another end of the cell stack 310, and the output port 334 is disposed on another end of the gas output passage 332. The output baffle plate 336 is disposed in the gas output passage 332, and at least one end of the output baffle plate 336 may be connected to the sidewall of the gas input passage 332 so as to be located in front of the output port 334, and a gap exists between the output baffle plate 336 and the output port 334. Furthermore, a width of the output baffle plate 336 is greater than an aperture diameter of the output port 334, in order to shield the output port 334.

Accordingly, when the output gas from the fuel cell stack 310 flows through the gas output passage 332 to the output port 334, as the output baffle plate 336 shields the output port 334 to reduce the practical aperture diameter, and the output baffle plate 336 also cause the output gas to be separated to flow towards two sides of the gas output passage 332, the gas pressure of the gas output unit 330 can be greatly increased, so as to compensate the inner pressure loss of the fuel cell 300. Moreover, as the structure of the gas input unit 320 is so similar to the one in the embodiment mentioned above that the similarities are not repeated here.

Although specific embodiments have been illustrated and described, it will be appreciated by those skilled in the art that various modifications may be made without departing from the scope of the present invention, which is intended to be limited solely by the appended claims.

What is claimed is:

1. A fuel cell for improving flow field uniformity and reducing gas pressure loss, comprising:
a fuel cell stack; and
a gas input unit, comprising:
a gas input passage, wherein an end of the gas input passage is connected to an end of the fuel cell stack;
an input port, disposed on another end of the gas input passage;
an input baffle plate, disposed in the gas input passage and located in front of the input port, wherein a gap exists between the input baffle plate and the input port; and
at least one perforated plate, disposed between the input baffle plate and the fuel cell stack.

2. The fuel cell of claim 1, wherein a width of the gas input passage is greater than an aperture diameter of the input port.

3. The fuel cell of claim 1, wherein a width of the input baffle plate is greater than an aperture diameter of the input port.

4. The fuel cell of claim 1, wherein at least one end of the input baffle plate is connected to a sidewall of the gas input passage.

5. The fuel cell of claim 1, wherein the input baffle plate has a rectangular shape.

6. The fuel cell of claim 1, wherein the perforated plate has a plurality of holes.

7. The fuel cell of claim 1, wherein at least one end of the perforated plate is connected to a sidewall of the gas input passage.

8. The fuel cell of claim 1, wherein a shape of the perforated plate substantially complements a shape of the input baffle plate.

9. The fuel cell of claim 1, wherein the perforated plate has a rectangular shape.

10. A fuel cell for improving flow field uniformity and reducing gas pressure loss, comprising:
a fuel cell stack;
a gas input unit, comprising:
a gas input passage, wherein an end of the gas input passage is connected to an end of the fuel cell stack;
an input port, disposed on another end of the gas input passage;
an input baffle plate, disposed in the gas input passage and located in front of the input port, wherein a gap exists between the input baffle plate and the input port; and
at least one perforated plate, disposed between the input baffle plate and the fuel cell stack; and
a gas output unit, disposed on another end of the fuel cell stack, wherein the gas output unit includes:
a gas output passage, wherein an end of the gas output passage is connected to another end of the fuel cell stack;
an output port, disposed on another end of the gas output passage; and
an output baffle plate, disposed in the gas output passage and located in front of the output port, wherein a gap exists between the output baffle plate and the output port.

11. The fuel cell of claim 10, wherein a width of the output baffle plate is greater than an aperture diameter of the output port.

12. The fuel cell of claim 10, wherein at least one end of the output baffle plate is connected to a sidewall of the gas output passage.
